(19) United States
(12) Patent Application Publication
(10) Pub. No.: US 2010/0195910 A1
(43) Pub. Date: Aug. 5, 2010

(54) METHOD AND ELECTRONIC DEVICE FOR ATTACHING HANDWRITTEN INFORMATION TO AN ELECTRONIC DOCUMENT

(75) Inventors: YIH TAY TSAY, HSINCHU (TW); WEI HSIN KUO, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: PENPOWER TECHNOLOGY LTD, HSINCHU (TW)

(21) Appl. No.: 12/364,699

(22) Filed: Feb. 3, 2009

(51) Int. Cl. G06K 9/00; G06F 3/041; G09G 5/00

(52) U.S. Cl. 382/189; 345/173; 345/156

(57) ABSTRACT

A method for attaching handwritten information to an electronic document comprises the steps of displaying a handwriting area of an electronic document on a displaying apparatus; adjusting the location or the size of the handwriting area according to commands from an electronic device; detecting handwritten information by a touch screen on the electronic device; translating the handwritten information into an information file by the electronic device; and attaching the information file to the handwriting area on the electronic document.

### BACKGROUND OF THE INVENTION

(A) Field of the Invention

The present invention relates to an electronic device, and more particularly, to a touch screen.

(B) Description of the Related Art

It is customary for people to sign on a document, for example, an executive signing on a resignation approval, or a customer signing on a contract, to confirm or approve the context of the document. If the document is an electronic document, e.g. a Microsoft Word file, traditionally, it has to be printed out for such person to sign on manually. However, not only will it cost a lot of money to print such documents when the number of such documents is increasing and accumulating at a high rate, but also the room and space to store such documents is a burden to both companies and individuals.

With the commercialization of the touch screen technology, it has become an alternative as an input device of a computer system. The application of the touch screen technology ranges from public computer-aid terminal devices, such as ATM machines or tourist guiding machines, to mobile electronic device, such as personal digital assistances or the Nintendo Duo Screen (NDS) systems. Combining the touch screen technology with the handwriting recognition technology, it is even possible for users input their handwriting information into computer devices via touch screens.

Despite the convenience of the touch screen technology, few applications have been developed to realize signature signing on electronic documents via touch screens. It is because that to display the electronic documents on the touch screens, the required area of such touch screens is too large to be cost effective. Nevertheless, the present invention brilliantly provides methods and electronic devices to realize signature signing on electronic documents via touch screens.

### SUMMARY OF THE INVENTION

A method for attaching handwritten information to an electronic document according to embodiments of the present invention comprises the steps of displaying a handwriting area of an electronic document on a displaying apparatus; adjusting the location or the size of the handwriting area according to commands from an electronic device; detecting handwritten information by a touch screen on the electronic device; translating the handwritten information into an information file by the electronic device; and attaching the information file to the handwriting area on the electronic document.

According to embodiments of the present invention, a software product performs the aforesaid method when loaded and executed by a computer or an electronic device.

An electronic device according to embodiments of the present invention comprises a touch screen and a user-adjusting interface. The touch screen is configured to detect handwritten information. The user-adjusting interface is configured to receive user-input commands to adjust the displaying of the handwritten information on a displaying apparatus.

### BRIEF DESCRIPTION OF THE DRAWINGS

The objectives and advantages of the present invention will become apparent upon reading the following description and upon reference to the accompanying drawings in which:

FIG. 1 shows the schematic view of an electronic device according to embodiments of the present invention; and

FIG. 2 shows the flow chart of a method for attaching handwritten information to an electronic document according to embodiments of the present invention.

### DETAILED DESCRIPTION OF THE INVENTION

Embodiments of the present invention will now be described more fully with reference to the accompanying drawings. The present invention may, however, be embodied in many different forms and should not be construed as limited to the embodiments set forth herein. Rather, these embodiments are provided so that this disclosure will be thorough and complete, and will fully convey the scope of the present invention to those skilled in the art.

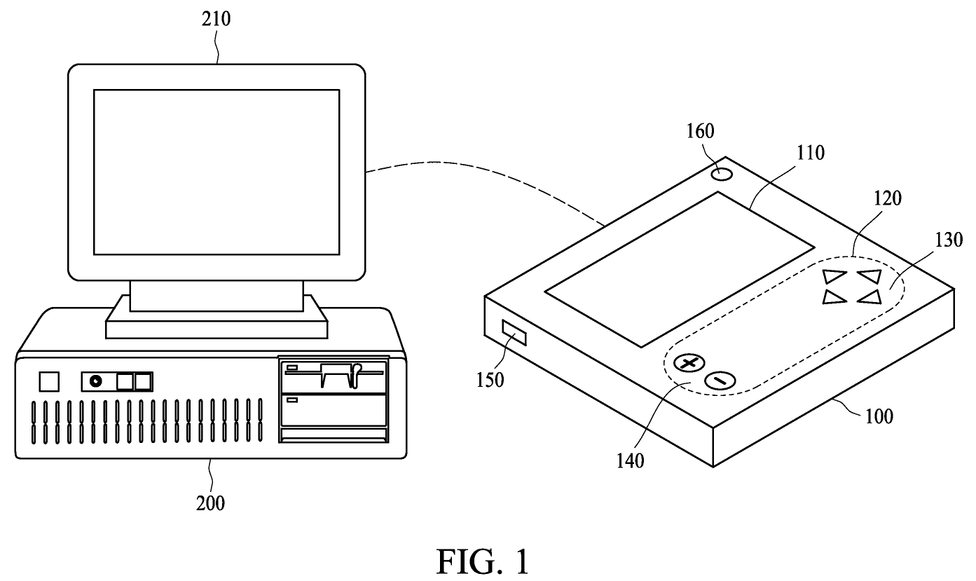

FIG. 1 shows the schematic view of an electronic device according to embodiments of the present invention. The electronic device 100 has a communication link, wired or wireless, with a computer system 200 comprising a displaying apparatus 210. The electronic device 100 comprises a touch screen 110 and a user-adjusting interface 120. The touch screen 110 is configured to detect handwritten information. The user-adjusting interface 120 is configured to receive user-input commands to adjust the displaying of the handwritten information on the displaying apparatus 210. The user-adjusting interface 120 comprises a location-adjusting button set 130 and a size-adjusting button set 140. The location-adjusting button set 130 is configured to receive user-input commands to adjust the location of the displaying of the handwritten information. The size-adjusting button set 140 is configured to receive user-input commands to adjust the size of the displaying of the handwritten information.

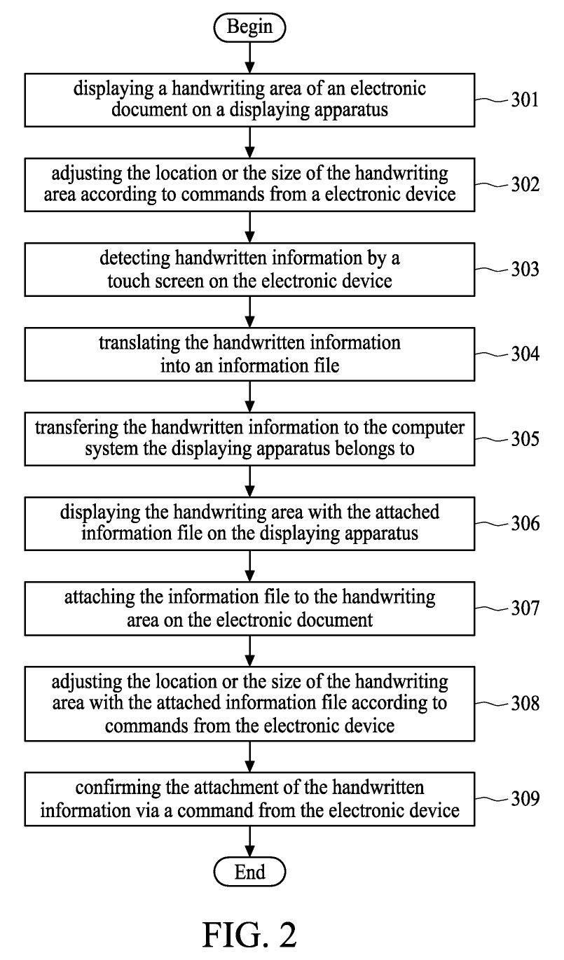

FIG. 2 shows the flow chart of a method for attaching handwritten information to an electronic document according to embodiments of the present invention, wherein the method is applied to the electronic device 100 of FIG. 1. In step 301, a handwriting area of an electronic document is displayed on the displaying apparatus 210. In step 302, the location or the size of the handwriting area is adjusted according to commands from the electronic device 100. In step 303, the touch screen 110 on the electronic device 100 detects handwritten information. In step 304, the electronic device 100 translates the handwritten information into an information file, wherein in some embodiments, the information file is an image file. In step 305, the electronic device 100 transfers the handwritten information to the computer system 200 which the displaying apparatus 210 belongs to. In step 306, the handwriting area with the attached information file is displayed on the displaying apparatus 210. In step 307, the information file is attached to the handwriting area on the electronic document. In step 308, the location or the size of the handwriting area with the attached information file is adjusted according to commands from the electronic device 100. In step 309, the attachment of the handwritten information is confirmed via a command from the electronic device 100.

Referring to both FIG. 1 and FIG. 2, the adjustment commands of step 302 and 308 is received via the location-adjusting button set 130 and the size-adjusting button set 140. That is, the touch screen 110 displays the handwriting area on the electronic document. When the size of the handwriting area is expanded, the resolution of the touch screen 110 is reduced. When the size of the handwriting area is shrunk, on the other hand, the resolution of the touch screen 110 is increased. In some embodiments of the present invention, step 304, 305 and 306 are executed simultaneously. That is, the information file is produced and displayed on the displaying apparatus 210 while a user inputs his or her handwriting information via the touch screen 110. In this way, the user can monitor its handwriting information via the displaying apparatus 210 during his or her writing procedure. Therefore, when the handwriting area is a signature column or a signature line, which is usually relatively small in the size compared to the electronic document thereof, or the user is to input his or her signature as the handwritten information, the user can expand the handwriting area to a full screen such that he or her can have a clear view of his or her handwriting, as described in step 302. After the user finishes his or her handwriting procedure, he or her can shrink the handwriting area to its normal size and relocates the handwriting area to its original location, as described in step 308.

Referring back to FIG. 1, in some embodiments, the electronic device 100 further comprises a USB port 150, which serves as a power input. In other embodiments, the electronic device 100 further comprises an indicator light 160, which may indicate the remaining energy or other status of the electronic device 100. In some embodiments, the electronic device 100 further comprises a processing unit for the recognition of the handwritten information. In other embodiments, the electronic device 100 has a virtual keyboard displaying on the touch screen 110 such that users can input information other than handwritings via the touch screen 110. In some embodiments, the electronic device 100 further comprises a stylus and its holder, wherein the stylus serves as a media for the user to input handwritten information. In other embodiments, the electronic device 100 can serve as a telephone for users to communicate with other electronic devices. In some embodiments, the electronic device 100 can serve as a calculator. In other embodiments, the electronic device 100 can serve as a video game console. In some embodiments, the electronic device 100 can support on line communication such as Microsoft Windows Live Messenger.

In conclusion, the present invention provides methods and electronic devices to realize signature signing on electronic documents via touch screens, such that users can comfortably input and observe his or her handwritings simultaneous. In addition, the size of the touch screen can be relatively small such that it can be easily implemented with relatively low cost.

The above-described embodiments of the present invention are intended to be illustrative only. Those skilled in the art may devise numerous alternative embodiments without departing from the scope of the following claims.

What is claimed is:

1. A method for attaching handwritten information to an electronic document, comprising the steps of:
displaying a handwriting area of an electronic document on a displaying apparatus;
adjusting the location or the size of the handwriting area according to commands from an electronic device;
detecting handwritten information by a touch screen on the electronic device;
translating the handwritten information into an information file by the electronic device; and
attaching the information file to the handwriting area on the electronic document.

2. The method of claim 1, wherein the information file is an image file.

3. The method of claim 1, further comprising the step of:
transferring the handwritten information from the electronic device to the computer which the displaying apparatus belongs to.

4. The method of claim 1, wherein the detecting and the translating steps are executed simultaneously, and the information file is displayed in the handwriting area on the displaying apparatus while the detecting and the translating steps are executed.

5. The method of claim 1, further comprising the steps of:
displaying the handwriting area with the attached information file on the displaying apparatus; and
adjusting the location or the size of the handwriting area with the attached information file according to commands from the electronic device.

6. The method of claim 1, further comprising the step of:
confirming the attachment of the handwritten information via a command from the electronic device.

7. The method of claim 1, wherein the handwriting area is a signature column or a signature line.

8. The method of claim 1, wherein the handwritten information is a signature.

9. A software product, when loaded and executed by a computer or an electronic device, performing the method of claim 1.

10. An electronic device comprising:
a touch screen configured to detect handwritten information; and
a user-adjusting interface configured to receive user-input commands to adjust the displaying of the handwritten information on a displaying apparatus.

11. The electronic device of claim 10, wherein the user-adjusting interface comprises:
a location-adjusting button set configured to receive user-input commands to adjust the location of the displaying of the handwritten information.

12. The electronic device of claim 10, wherein the user-adjusting interface comprises:
a size-adjusting button set configured to receive user-input commands to adjust the size of the displaying of the handwritten information.

13. The electronic device of claim 10, which further comprises a processing unit for the recognition of the handwritten information.

14. The electronic device of claim 10, which has a virtual keyboard displaying on the touch screen.

15. The electronic device of claim 10, which further comprises a USB port capable of serving as a power input.

16. The electronic device of claim 10, which further comprises an indicator light.

17. The electronic device of claim 10, which further comprises a stylus and its holder.

18. The electronic device of claim 10, which can serve as a telephone.

19. The electronic device of claim 10, which can serve as a calculator.

20. The electronic device of claim 10, which can serve as a video game console.

21. The electronic device of claim 10, which can support on line communication.
